(19) United States
(12) Patent Application Publication
(10) Pub. No.: US 2012/0085216 A1
(43) Pub. Date: Apr. 12, 2012

(54) Slicing Machine for Food Products

(75) Inventors: Corrado Lobbia, Vicenza (IT); Lino Pasin, Schio (IT)

(73) Assignee: ROLLMATIC S.R.L., Schio (IT)

(21) Appl. No.: 13/252,571

(22) Filed: Oct. 4, 2011

(30) Foreign Application Priority Data
Oct. 8, 2010 (IT) VI2010A0000272

(51) Int. Cl. B26D 7/00

(52) U.S. Cl. 83/821

(57) ABSTRACT

The invention is a slicing machine (1) for food products, especially bread, comprising: a floor standing casing (2); a frame (3, 4) supporting a plurality of blades (5) parallel to one another: guide means (6) of the frame (3, 4) according to a movement direction (X); actuator means (7) operatively connectable to the guide means (6), configured so as to give the frame (3, 4) an alternating motion along the movement direction (X). The frame (3, 4) and the guide means (6) are supported by a support structure (8) removably connectable to the casing (2) by coupling means (9).

### FIELD OF THE INVENTION

The present invention relates to a slicing machine for food products, especially bread and other similar baked goods, particularly suitable for use in bakeries and in the food industry.

### BACKGROUND OF THE INVENTION

Slicing machines comprised of a floor standing casing with two frames fastened to it, each of which supports a plurality of mutually parallel blades, are known and already exist.

The blades of each frame are interposed between the blades of the other frame so as to define a single row of reciprocally aligned blades, through which the product to be sliced is passed.

The machine also includes an actuator assembly which imparts an alternative motion to each frame in a direction of movement parallel to the blades and in an opposite sense with respect to the motion of the other frame.

The products to be sliced are supported by a support surface and are carried to the blades in different ways, such as through a conveyor belt, or through a movable plate which pushes them toward the blades themselves.

Sometimes there is the need to change the slicing thickness, which can be achieved by changing the pitch of the blades.

To meet the above requirements, a known embodiment of a slicing machine comprises frames removably connected to the respective actuator assembly through screws or other equivalent connection means, arranged in such a way as to be accessible by opening the machine casing.

This makes it possible to replace the frames with others featuring a different blade pitch and also allows the machine to be repaired in case one or more blades of the frames in question break's.

However, due to the need to open the casing of the machine and to have access to the inside to replace the frames, this operation has the disadvantage of being complicated, thus requiring the intervention of a specialized technician, which involves significant labour costs.

Furthermore, after the replacement of the frames, they must be adjusted to ensure that they are mutually aligned and that the distances between the respective blades are correct, further complicating the above operation and increasing the time needed to complete it.

The need to involve a technician involves the further disadvantage that the machine may be inoperative for a considerable time, at the expense of production.

A further drawback is due to the fact that the support surface that supports the products to be sliced has a plurality of slots for the passage of the blades.

In addition, many slicing machines are also provided with a comb-shaped pressure element with its teeth interposed between the blades which keeps the products to be sliced in contact with the support surface during the cutting operation to prevent the movement of the products that might cause an irregular cut.

Since the distance between the slots of the support surface and between the teeth of the pressure element corresponds to the pitch of the blades, these two elements are suitable only for frames equipped with fixed pitch blades, while they are unsuitable for blades having a different pitch.

Therefore, the replacement of the frames with others featuring a different blade pitch also requires the replacement of the support surface and the pressure element, with the disadvantage of further complicating the work on the machine and, therefore, worsening the aforementioned disadvantages.

### BRIEF SUMMARY OF THE INVENTION

The present invention intends to overcome all the disadvantages described above relating to slicing machines of the known type.

In particular, the primary object of the invention is to provide a machine for slicing food products in which the replacement of the frames is easier compared to slicing machines of the known type.

In particular, the object of the invention is to allow the frames to be replaced directly by the operator, that is, without the intervention of specialized technicians.

Another object of the invention is to avoid the need to adjust the frames after the replacement.

These objects are achieved by a slicing machine made according to the main claim.

Further details of the slicing machine of the invention are specified in the dependent claims.

Advantageously, the fact that the frames can be replaced more easily and without the assistance of a technician makes this operation quicker and cheaper than those required for machines of the known type.

In particular, the replacement can be made at any time directly by the operator, with the advantage of reducing the downtime involved.

### BRIEF DESCRIPTION OF THE DRAWINGS

These objects and advantages, along with others that will be mentioned below, will be highlighted in the descriptions of some preferred embodiments of the invention that are provided by way of non-limiting examples with reference to the following drawings attached, wherein:

FIG. 1 shows an axonometric view of the slicing machine of the invention;

FIG. 2 shows the machine of FIG. 1 exploded and partially sectioned;

FIG. 3 shows a detail of the machine of FIG. 1 in a different operating configuration;

FIGS. 4 and 5 show a side view of the machine of FIG. 1, partially sectioned, in two different operating configurations during operation;

FIGS. 6 and 7 show a side view of the machine of FIG. 1, partially sectioned, in two different operating configurations during the removal of the frames;

FIGS. 8 and 9 show a side view of the machine of FIG. 1 in two different operating configurations during the removal of the frames;

FIG. 10 shows a side view of an alternative embodiment of the machine of FIG. 1, partially sectioned.

### DETAILED DESCRIPTION OF THE INVENTION

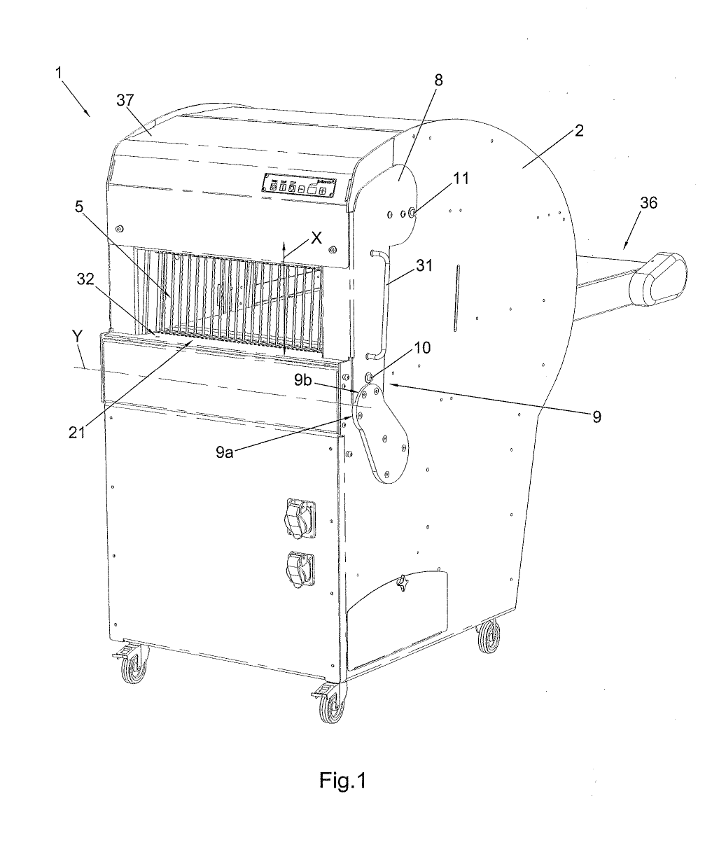

The slicing machine that is the subject of the invention, particularly suitable for use in bakeries and in the food industry for slicing bread or baked goods in general, is shown in FIG. 1 where it is indicated as a whole by 1.

Clearly the machine 1 can also be used for slicing food products other than baked goods, provided that they have the appropriate consistency.

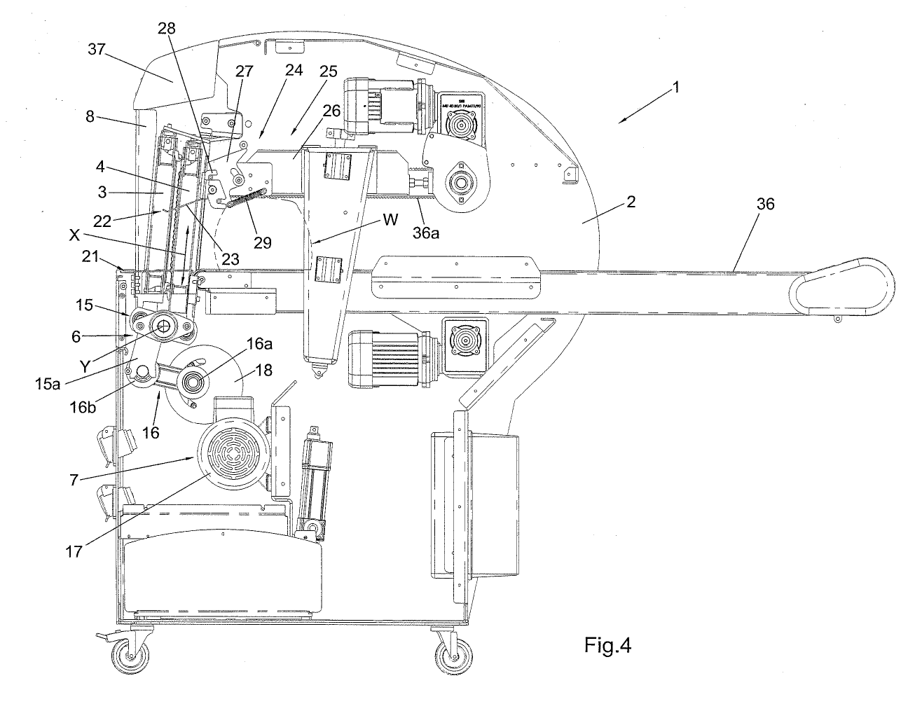

The machine 1 comprises a floor standing casing 2, which is preferably equipped with wheels to allow its movement and is associated with two frames 3 and 4, visible in FIG. 4, each of which supports a plurality of blades 5 parallel to each other.

It is specified that the alternative embodiments of the machine of the invention may be provided with a number of frames other than two, just one for example.

Clearly, what is described below is also applicable to these alternative embodiments with the obvious necessary adaptations.

The blades 5 of each frame 3, 4 are interposed between the blades 5 of the other frame 3, 4 and substantially aligned with them, in such a way as to define a single row of blades in the overall ensemble.

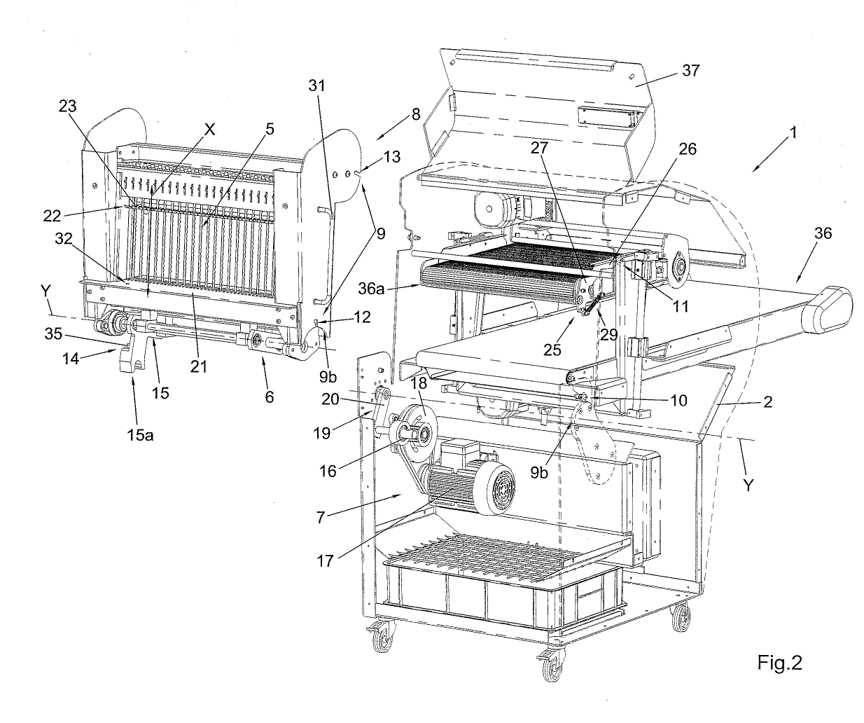

The frames 3 and 4 are associated with guide means 6 which define for each frame 3, 4 a movement direction X preferably parallel to the direction of development of the blades 5, as seen in the exploded view of FIG. 2, where a side of the machine 1 is deliberately shown in transparency so as to enable the inner part of the machine to be seen.

The guide means 6 preferably but not necessarily comprise a guide arm 15 rotatably associated with the support structure 8 around an axis of rotation Y.

The base of each frame 3, 4 is hinged to a corresponding end of the guide arm 15 such that the rotation of the guide arm 15 around the axis of rotation Y produces a simultaneous movement of the two frames 3, 4 in opposite directions with respect to each other.

In addition, the guide arm 15 is operatively connected to actuator means 7, configured in such a way as to rotate the guide arm 15 alternately according to opposing directions, so that each frame 3, 4 is alternately moved in opposing senses with respect to the movement direction X.

Obviously, alternative embodiments of the invention may comprise guide means 6 other than those described above, provided that they are suited to enable the movement of each frame 3, 4 in a movement direction X.

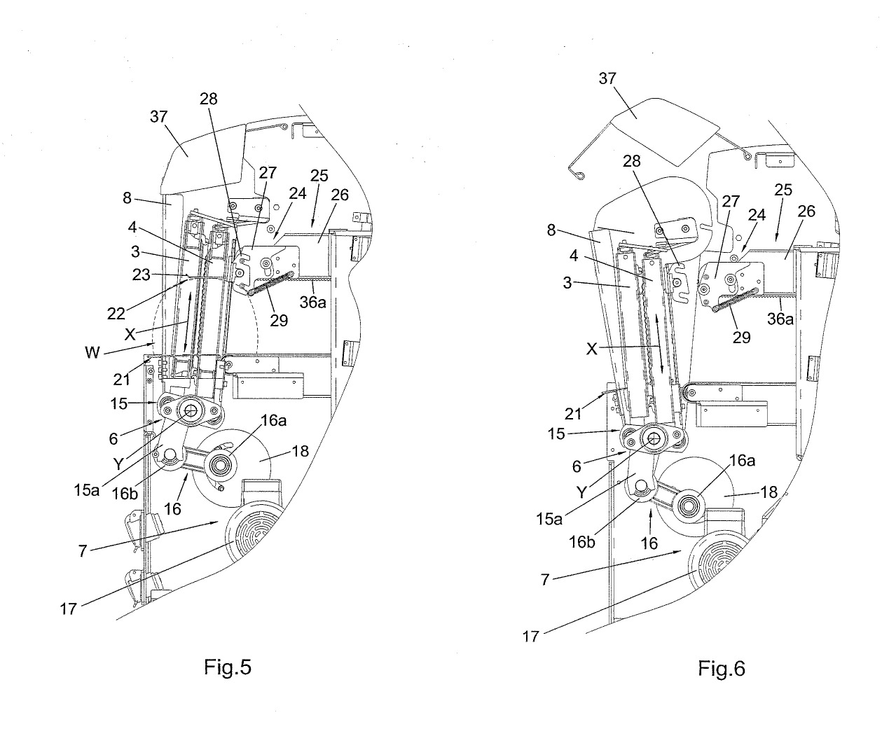

As can be seen in FIGS. 4 and 5, the food product W to be sliced, preferably a loaf of bread, is placed on a support surface 21 incident on said movement direction X and is pushed towards the blades 5 by a first conveyor belt 36, or by any means of conveyance of the known type.

Preferably, the support surface 21 has a plurality of slots suited to accommodate the blades 5, whose mutual distance corresponds to the pitch of the blades 5 themselves.

Preferably but not necessarily, there is a second conveyor belt 36a facing the first, which advantageously increases the transport efficiency.

According to the invention, the frames 3, 4 and the related guide means 6 are supported by a single support structure 8 removably connectable to the casing 2 by coupling means 9.

Advantageously, the removal of the support structure 8 from the casing 2 allows the removal of the frames 3, 4 together with the guide means 6, with no need to separate the two components.

Consequently, the removal of the frames 3, 4 does not require access to the inside of the machine 1, making the removal of the frames 3, 4 of the slicing machine 1a much simpler operation, and thus achieving one of the objects of the invention.

In particular, the support structure 8 can be removed directly by the operator with no need to call in a specialized technician to access the inside of the machine 1.

Moreover, advantageously, once the support structure 8 has been removed, it can just as easily be replaced with a support structure of a similar nature, minimizing the overall time involved for the operation and thus the downtime.

Further advantageously, it is possible to include a series of interchangeable support structures 8, each of which has frames 3, 4 with different pitches of the blades 5, corresponding to different slicing thicknesses.

Moreover, since both frames 3 and 4 are associated with the support structure 8, it is possible to remove them simultaneously, allowing further simplification of the operation.

As a further advantage, the support structure 8 keeps the frames 3, 4 connected to the guide means 6 even when it is removed from the casing 2, maintaining the correct position of the frames 3, 4 with respect to the guide means 6 as well as the reciprocal position of the frames themselves.

Therefore, advantageously, the need to adjust the positions of the frames 3, 4 after replacement is avoided, again to the advantage of the simplicity and rapidity of the operation.

Preferably, the support surface 21 also belongs to the support structure 8 in such a way that, when it is replaced with another one featuring a different pitch of the blades 5, the new support structure 8 is already equipped with the support surface 21 provided with slots at the same pitch as the blades 5, with a resulting advantage consisting in greater ease of replacement.

As regards the coupling means 9 of the support structure 8 to the casing 2, these are configured in such a way as to define, for the support structure 8, a connecting trajectory that extends between a connection position, in which the support structure 8 can be stably associated with the casing 2, and a release position, in which the support structure 8 can be removed from the casing 2.

Advantageously, the presence of this connecting trajectory enables the simplification of the coupling operation, making it also more precise.

Preferably, the coupling means 9 are arranged so as to be easily accessible from the outside of the machine 1, to the advantage of the ease of removal of the support structure 8.

More precisely, the coupling means 9 preferably comprise two protruding bodies 10 and 11 arranged on each side of the casing 2, which are slidingly housed inside corresponding guide slots 12 and 13 belonging to each side of the support structure 8.

The configuration of the guide slots 12, 13 and the arrangement of the related protruding bodies 10, 11 are such that their reciprocal sliding determines the movement of the support structure 8 along the connecting trajectory.

This is achieved, preferably, giving the lower slots 12 a substantially L-shaped profile, comprising a first substantially vertical section which opens at the lower edge of the casing 2, which connects to a second substantially horizontal section.

On the contrary, the upper slots 13 have substantially horizontal profiles.

In this way, the support structure 8 can be coupled to the casing 2 by tilting it outwards and sliding the lower protruding bodies 10 along the first section of the corresponding lower slots 12 in a substantially vertical direction.

Once the protruding bodies 10 have reached the bottom of the first section of the slots 12, it is possible to push the support structure 8 in such a way as to make the protruding bodies 10 slide along the second section of the lower guide slots 12, while the upper protruding bodies 11 will couple with their respective upper guide slots 13, sliding all the way to the end of the stroke.

Preferably, the protruding bodies 10 and 11 are screws associated with corresponding nuts belonging to the casing 2.

During the insertion of the support structure 8, these screws can be loosened, while screwing them enables the support structure 8 to be secured after it has been properly positioned.

Preferably, these screws have a thread with a smaller diameter compared to the width of the respective guide slots 12, 13 and an area with larger diameter than the former, which enables the centering of the support structure 8 with respect to the slots 12, 13 themselves.

Clearly, in alternative embodiments of the invention, the coupling and fastening of the support structure 8 to the casing 2 can be obtained using any other coupling means 9 of the known type.

For example, one of these alternative embodiments, not shown, can comprise guide slots 12, 13 belonging to the casing 2 and protruding bodies 10, 11 belonging to the support structure 8.

According to a further alternative embodiment, also not shown, the protruding bodies 10 and 11 are threaded and cooperate with corresponding nuts to fasten the support structure 8.

As regards the actuator means 7, as seen for example in FIG. 2, these preferably include a connecting rod 16 having a first end 16a operatively connected to a gearmotor 17 by means of a crank 18.

The second end 16b of the connecting rod 16 is connected to a first end 15a of the guide arm 15 through removable joint means 14.

These removable joint means 14 enable the replacement of the support structure 8 with no need to dismantle the actuator means 7 or remove them from the casing 2 to which they are fastened, with the added benefit of easy removal of the support structure 8 itself.

Preferably but not necessarily, the removable joint means 14 comprise a screw 35 arranged so that it passes through said first end 15a of the guide arm 15 and screwable onto the second end 16b of the connecting rod 16.

Preferably, the actuator means 7 also comprise a support element 19 associated with the casing 2, operatively connected to the second end 16b of the connecting rod 16.

The aforementioned support element 19 is configured so as to maintain the second end 16b of the connecting rod 16 in its normal working trajectory, corresponding to the trajectory described by the movement of the first end 15a of the guide arm 15, even when the support structure 8 is removed and thus the guide arm 15 is disconnected from the connecting rod 16.

When the guide arm 15 is disconnected from the connecting rod 16, the aforementioned support element 19 prevents the latter from rotating spontaneously and adopting a position with the second end 16b pointing downward, making the subsequent connection to the guide arm 15 difficult.

On the contrary, the support element 19 maintains the rod 16 in a position suited to meet the guide arm 15 during the coupling of the support structure 8.

Therefore, advantageously, the support element 19 enables the is connection of the connecting rod 16 to the guide arm 15 with no need to access the inside of the machine 1 and, therefore, facilitates the connection of the support structure 8.

Preferably but not necessarily, the support element 19 comprises a support arm 20, one of the ends of which is rotatably connected to the casing 2 coaxially to the axis of rotation Y of the guide arm 15, while the opposite end is rotatably connected to the second end 16b of the connecting rod 16.

Clearly, in alternative embodiments of the invention not shown herein, the support element 19 may be a sliding guide, or any other element which is able to maintain the connecting rod 16 in the trajectory described above.

Preferably, the coupling means 9 also comprise a coupling surface 9a belonging to the casing 2, which has a circular profile the centre of which belongs to the axis of rotation Y of the guide arm 15, as seen for example in FIG. 1.

The support structure 8 comprises a corresponding counter-surface 9b connectable to the above coupling surface 9a.

Clearly, the coupling surface 9a and the counter-surface 9b define a connection trajectory of the support structure 8 to the casing 2 which corresponds to a rotation of the support structure 8 itself around the axis of rotation Y of the guide arm 15.

Advantageously, the presence of the coupling surface 9a facilitates the assembly of the support structure 8 since it enables the coupling to be carried out while at the same time maintaining the support structure 8 supported by the casing 2.

In addition, the circular profile of the coupling surface 9a favours the centering of the support structure 8 on the casing 2 and, therefore, ensures the regular operation of the machine 1. In fact, to have proper movement of the guide arm 15, its axis of rotation Y must be in the middle of the trajectory of the second end 16b of the connecting rod 16. Since the coupling of the support structure 8 to the casing 2 occurs by means of its rotation around the same axis of rotation Y above, it follows that the condition mentioned above is always satisfied.

The positioning accuracy thus obtained ensures, advantageously, the regular operation of the machine 1 and prevents possible wear to the joints of the guide means 6 and actuator means 7.

Moreover, advantageously, the simplicity of the coupling is further favoured and the need for subsequent adjustments is avoided.

Clearly, in alternative embodiments of the invention, the guide slots 12, 13 may have circular arc profiles with centres set on the axis of rotation Y, so as to perform the same functions as the coupling surface 9a and counter-surface 9b above.

Preferably, and as seen particularly in FIGS. 4 and 5, the slicing machine 1 also comprises a pressure element 22 which keeps the food product W to be sliced in contact with the support surface 21.

The aforementioned pressure element 22 comprises a plurality of protruding bodies 23 interposed between the blades 5 of the frames 3, 4 and facing the support surface 21.

There are also handling means 24 suitable to define a sliding direction of the pressure element 22 parallel to the movement direction X of the frames.

These handling means 24 are associated with adjusting means 25 able to vary the distance between the pressure element 22 and the support surface 21.

Advantageously, the adjusting means 25 enable the position of the pressure element 22 to be adjusted to loaves W of different heights.

Preferably, the aforementioned handling means 24 belong to the support structure 8 and thus the pressure element 22 is slidingly associated with the support structure 8 itself.

In addition, preferably, the adjusting means 25 comprise a motorized unit 26 associated with the casing 2 by means of actuators of the known type for movement in a direction substantially parallel to the movement direction X of the frames 3, 4.

The motorized unit 26 is equipped with a shaped body 27 removably connectable to a corresponding shaped profile 28 belonging to the pressure element 22.

In this way, the pressure element 22 can be disconnected from the adjusting means 25 when the support structure 8 is removed from the casing 2, as shown in FIG. 6.

Therefore, advantageously, each support structure 8 can have its own built-in pressure element 22 which is compatible with the pitch of the blades 5 of the respective frames 3 and 4.

This enables, advantageously, the attainment of complete interchangeability between various support structures 8 even if they feature different configurations of the blades 5 and, therefore, different pressure elements 22.

In fact, it is sufficient that all the support structures 8 are provided with respective shaped profiles 28 compatible with the shaped body 27.

Preferably, the shaped body 27 and the shaped profile 28 are configured to be mutually connected by effect of the movement of the support structure 8 along the connecting trajectory.

In this way, the connection between the shaped body 27 and the shaped profile 28 occurs spontaneously during the coupling of the support structure 8 to the casing 2, without the need for further operations by the operator.

In particular, the shaped body 27 includes two protrusions that are accommodated in corresponding slots of the shaped profile 28, in such a way that the movement of the shaped body 27 by means of the actuators of the motorized unit 26 will result in the movement of the shaped profile 28 and, therefore, of the pressure element 22.

Preferably, and as seen in FIGS. 4 and 5, the pressure element 22 is rotatably associated with the handling means 24 in such a way as to allow the protruding bodies 23 to approach and move away from the support surface 21.

Similarly, the shaped body 27 is rotatably associated with the motorized unit 26 through the interposition of elastic means 29 which, through the shaped body 27, push the protruding bodies 23 toward the support surface 21.

Advantageously, said elastic means 29 enable the pressure element 22 to stay in contact with the food product W even in the presence of normal variations in height that it may have.

It is obvious that the same effect could be obtained by using the weight of the pressure element 22 itself instead of using the elastic means 29, although in this case the pressure element 22 should have a great enough weight to keep the food product W resting on the support surface 21.

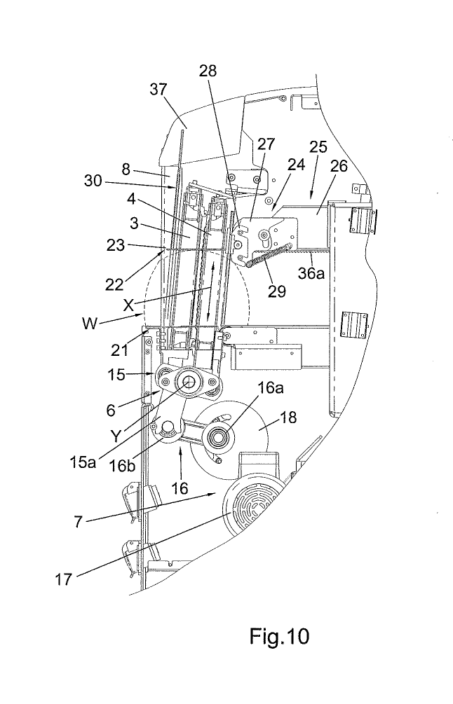

FIG. 10 represents an alternative embodiment of the machine of the invention that, compared to the machine described above, differs only in that it is equipped with a protective plate 30 to prevent the operator from accessing the upper part of the blades 5, with the benefit of increased safety of the machine 1.

The aforementioned protection plate 30 is slidingly associated with the support structure 8 and is resting on the pressure element 22, which supports it.

During the cutting of a food product W, the food raises the pressure element 22, which in turn raises the protection plate 30.

In this condition, the protection plate 30 prevents access to the upper part of the blades 5, while the lower part of the same is protected by the food product W.

After the food product W has been cut, the pressure element 22 lowers spontaneously as described above, also lowering the protection plate 30.

As a result, advantageously, the protection plate 30 keeps the upper part of the blades 5 inaccessible in any operating condition of the machine 1.

Operationally, to remove the support structure 8 from the machine 1 described above, the protruding bodies 10, 11 and the screw 35 which connects the connecting rod 16 to the guide arm 15 are first loosened.

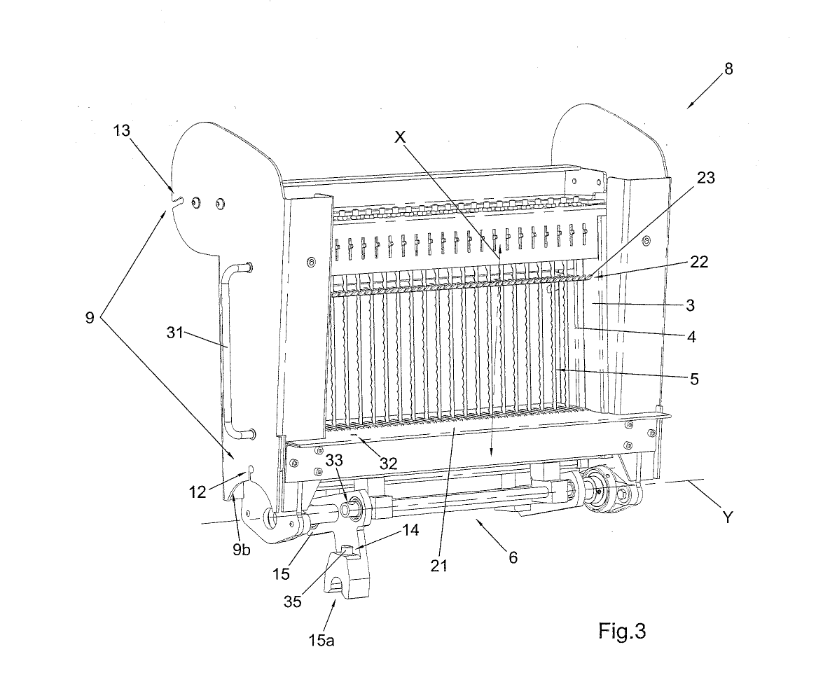

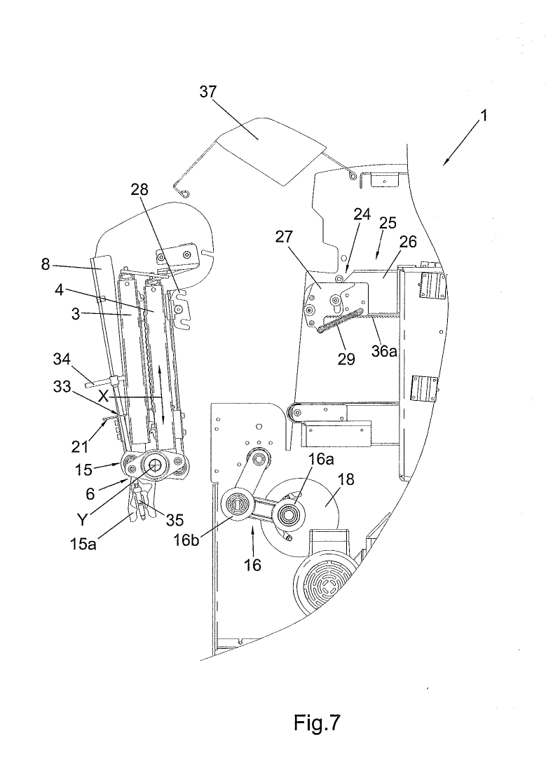

To facilitate this operation, the support structure 8 preferably comprises a guide hole 32 aligned with the head of the screw 35, visible for example in FIG. 2, through which a spanner 34, a screwdriver or a similar tool can be introduced, as shown in FIG. 3 and in the partial section of FIG. 7.

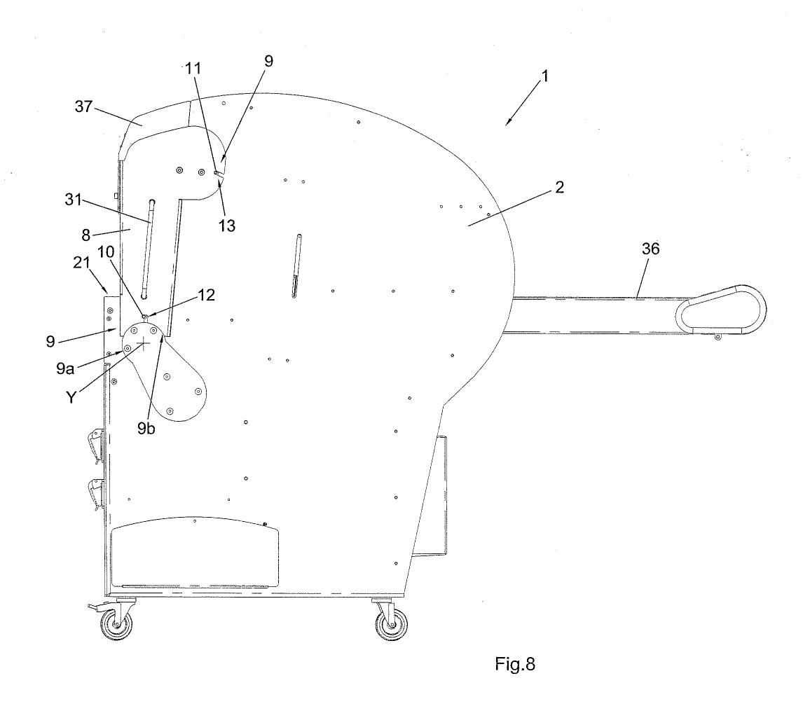

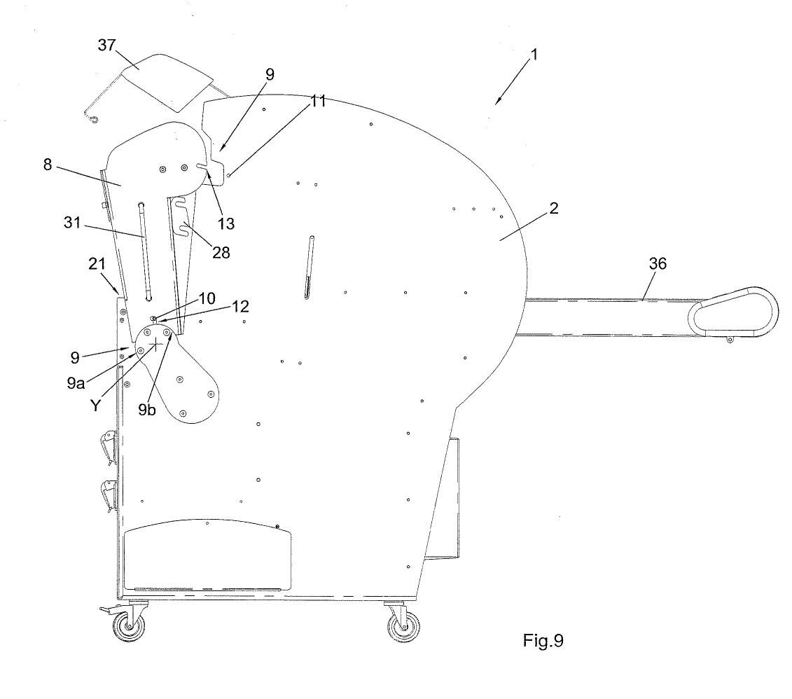

After removing the screws and lifting the upper protection plate 37, the support structure 8 can be rotated by sliding it along the coupling surface 9a of the casing 2, as can be seen in the sequence of FIGS. 8 and 9.

The above rotation enables the upper protruding bodies 11 to be released from the relative guide slots 13, in such a way as to be able to lift the support structure 8 by pulling the lower protruding bodies 10 out of their respective lower guide slots 12.

The above lifting is facilitated by suitable handles 31 which the support structure 8 is equipped with.

Obviously, the connection of the support structure 8 to the machine 1 is carried out completing the steps described above in reverse order.

To facilitate the connection, the guide arm 15 preferably comprises a through hole 33, visible in FIG. 3, arranged so as to be aligned with the guide hole 32 of the support structure 8 and with the head of the screw 35 when the guide arm 15 is placed in a pre-established position.

The user can then place the guide arm 15 in this pre-established position by introducing the spanner 34 in the two holes of the support structure 8 before connection, so that the spanner acts as a mechanical lock and prevents the movement of the guide arm 15.

The machine 1 also comprises a logic control unit which is able to position the connecting rod 16 in the position corresponding to said pre-established position of the guide arm 15.

In this way, the guide arm 15 and the connecting rod 16 can be arranged in corresponding positions prior to the coupling of the support structure 8 to the casing 2, to the advantage of ease of connection.

In addition, prior to the coupling, the spanner 34 can be inserted in the head of the screw 35, so that it is already set up to screw the screw 35 when the coupling has occurred.

Given the above, it is understood that the slicing machine described above achieves all the objects of the invention.

In particular, the integration of the frames and the related guide means into a single support structure which is easily removed from the casing of the machine enables the replacement of the frames with no need to separate them from the guide means, making the operation easier compared to slicing machines of the known type.

Consequently, the replacement of the frames can be made directly by the operator, without the intervention of a specialized technician.

The invention also makes it possible to avoid adjusting the frames after the replacement of the support structure, as they are stably connected to the guide means.

In the construction phase, further changes can be made to the slicing machine that is the subject of the invention which, even though not described herein and not shown in the drawings, must all be considered protected by this patent, provided that they fall within the scope of the dams that follow.

We claim:

1) Slicing machine for food products, especially bread, comprising:
a floor standing casing;
at least one frame supporting a plurality of blades parallel to one another;
guide means of said frame which define a movement direction for said frame;
actuator means operatively connectable to said guide means, configured so as to give said frame an alternating motion according to opposing senses with respect to said movement direction,
wherein said frame and said guide means are supported by a support structure removably connectable to said casing through coupling means.

2) Slicing machine according to claim 1), wherein said actuator means are connectable to said guide means through removable joint means.

3) Slicing machine according to claim 2), wherein said coupling means define, for said support structure, a connecting trajectory that extends between a connection position, in which said support structure can be stably associated with said casing, and a release position, in which said support structure can be removed from said casing.

4) Slicing machine according to claim 3), wherein said coupling means comprise a protruding body and a guide slot, respectively belonging to said casing and to said support structure or vice versa, said guide slot being suited to slidingly accommodate said protruding body during the movement of said support structure along said connecting trajectory.

5) Slicing machine according to claim 3), wherein said guide means comprise a guide arm rotatably associated with said support structure around an axis of rotation, said frame being hinged to said guide arm at a point spaced from said axis of rotation.

6) Slicing machine according to claim 5), wherein said actuator means comprise a connecting rod with a first end operatively connected to a gearmotor via a crank and a second end connected to a first end of said guide arm via said removable joint means.

7) Slicing machine according to claim 6), wherein said actuator means comprise a support element associated with said casing and operatively connected to said second end of said connecting rod, configured to maintain said second end of said connecting rod along the trajectory defined by the movement of said first end of said guide arm even when said removable joint means are removed and said support structure is disconnected from said casing.

8) Slicing machine according to claim 7), wherein said support element comprises a support arm having one end rotatably connected to said casing around said axis of rotation and the opposite end rotatably connected to said second end of said connecting rod.

9) Slicing machine according to claim 8), wherein said connecting trajectory corresponds to a rotation of said support structure around said axis of rotation.

10) Slicing machine according to claim 9), wherein said coupling means comprise a coupling surface belonging to said casing, having a circular profile the centre of which belongs to said axis of rotation, and a corresponding counter-surface belonging to said support structure, connectable to said coupling surface.

11) Slicing machine according to claim 5), wherein it comprises two of said frames hinged to said guide arm on mutually opposite sides with respect to said axis of rotation.

12) Slicing machine according to claim 1), wherein it comprises:
a support surface arranged so that it is incident on said movement direction, suited to support a food product to be sliced, particularly a loaf of bread;
a pressure element suited to press said food product against said support surface, provided with a plurality of protruding bodies interposed between said blades of said frame and facing said support surface;
handling means suited to define a sliding direction parallel to said movement direction for said pressure element;
adjusting means cooperating with said handling means to vary the distance between said pressure element and said support surface.

13) Slicing machine according to claim 12), wherein said handling means belong to said support structure, said adjusting means comprising a motorized unit associated with said casing by actuator means for movement in a direction substantially parallel to said movement direction and comprising a shaped body removably connectable to a shaped profile belonging to said pressure element.

14) Slicing machine according to claim 12), wherein said pressure element is rotatably associated with said guide means in such a way as to allow said protruding bodies to approach and move away from said support surface, said shaped body being rotatably associated with said motorized unit through elastic means suited to induce the spontaneous rotation of said shaped body in the direction corresponding to the approach direction of said protruding bodies to said support surface.

15) Slicing machine according to claim 10), wherein it comprises a protection plate suited to prevent the operator from accessing the blades, movably connected with said support structure and operatively connected to said pressure element so as to be moved as a result of the movement of the pressure element itself.
